(19) United States
(12) Patent Application Publication
(10) Pub. No.: US 2024/0324565 A1
(43) Pub. Date: Oct. 3, 2024

(54) Fishing Lure with Magnetic Hook Slot

(71) Applicant: Stephen Jansen, Cabo San Lucas (MX)

(72) Inventor: Stephen Jansen, Cabo San Lucas (MX)

(21) Appl. No.: 18/622,256

(22) Filed: Mar. 29, 2024

Related U.S. Application Data
(60) Provisional application No. 63/493,048, filed on Mar. 30, 2023.

(51) Int. Cl. A01K 85/16; A01K 85/00

(52) U.S. Cl. CPC A01K 85/16; A01K 85/1837

(57) ABSTRACT

A fishing lure with magnetic hook slot includes a lure body, a hook-positioning compartment, a magnet, and a fishing hook. The lure body is configured with a sagittal plane, a head section, a mid-section, a tail section, and a hook mount. The hook mount integrates into the mid-section as the head section and the tail section are oppositely positioned of each other about the mid-section. The hook-positioning compartment is positioned in between the hook mount and the tail section and traverses into a belly portion of the mid-section. The magnet hermetically mounts within the mid-section. The magnet is adjacently positioned atop the hook-positioning compartment so that the fishing hook can magnetically attach to the magnet. The eye of the fishing hook slidably mounts to the hook mount and magnetically attaches with the magnet through the mid-section as a shank of the fishing hook is angularly positioned to the lure body.

The current application claims a priority to the U.S. Provisional Patent application Ser. No. 63/493,048 filed on Mar. 30, 2023.

### FIELD OF THE INVENTION

The present invention relates generally to fishing lures. More specifically, the present invention is a fishing lure with at least one magnetic hook slot to angularly hold fishing hook in position during usage.

### BACKGROUND OF THE INVENTION

Various tools and accessories are generally used with fishing lures to effectively attract and catch fish. More specifically, fishing lures are commonly attached to a fishing line and include one or more hooks for catching fish as the lures are pulled through the water. Current fishing lures commonly include hooks that dangle freely from the lure body on a ring, causing the hook to orient unpredictably as the lure moves through the water, often positioning the hook in an unideal position during much of its use and damaging the lure through repeated collisions. Many fishing regulations do not allow the fishing hooks to be firmly fastened in place on the lure body for the protection of fish thus leading to most lures to have freely dangling hooks rather than structurally integrated into the lure body.

Therefore, an objective of the present invention is to overcome the above referenced limitations of known fishing lures by integrating a magnet and a slot into a lure body to angularly hold a fishing hook in position while still allowing the fishing hook to pull away from the lure body when pulled by an external force. Resultantly, the present invention is able to protect the structural integrity of the fishing hook and the lure body thus enhancing the reliability of the fishing lure.

### BRIEF DESCRIPTION OF THE DRAWINGS

FIG. 1 is a top perspective view of the present invention.

FIG. 2 is a bottom perspective view of the present invention.

FIG. 3 is a side view of the present invention.

FIG. 4 is a front view of the present invention.

FIG. 5 is a cross-sectional view taken along line 5-5 in FIG. 4.

FIG. 6 is a detailed view taken about circle 6 in FIG. 5 showing the right lateral wall.

FIG. 7 is a cross-sectional view taken along line 7-7 in FIG. 4.

FIG. 8 is a detailed view taken about circle 8 in FIG. 7 showing the left lateral wall.

FIG. 9 is a perspective view of the fishing hook of the present invention.

FIG. 10 is a side view of the present invention showing the angular positioning of the fishing hook.

### DETAILED DESCRIPTION OF THE INVENTION

All illustrations of the drawings are for the purpose of describing selected versions of the present invention and are not intended to limit the scope of the present invention.

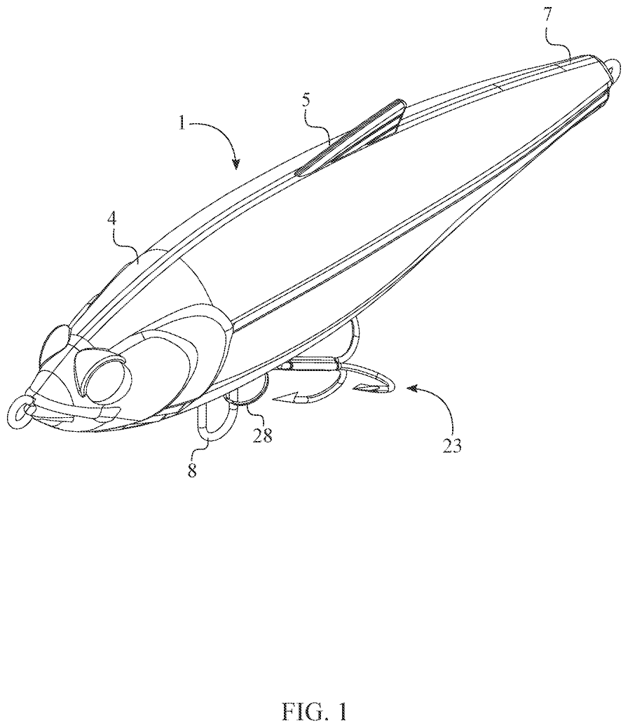

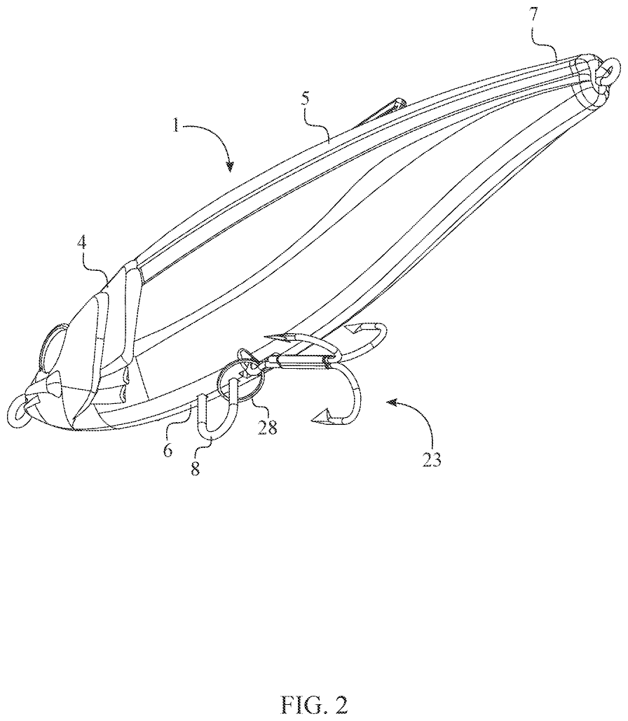

The present invention is a fishing lure with magnetic hook slot that is configured to magnetically retain at least one hook within a slot in the fishing lure. Due to the magnetic attachment, the present invention is able to protect the fishing lure and the fishing hook 23 as the fishing hook 23 does not suspend or swing around the fishing lure. Furthermore, the magnetic attachment is also able to comply with industry regulation as the fishing hook 23 is not configured as a fixed connection to the fishing lure. As shown in FIGS. 1-3, the present invention comprises a lure body 1, a hook-positioning compartment 14, a magnet 21, and a fishing hook 23.

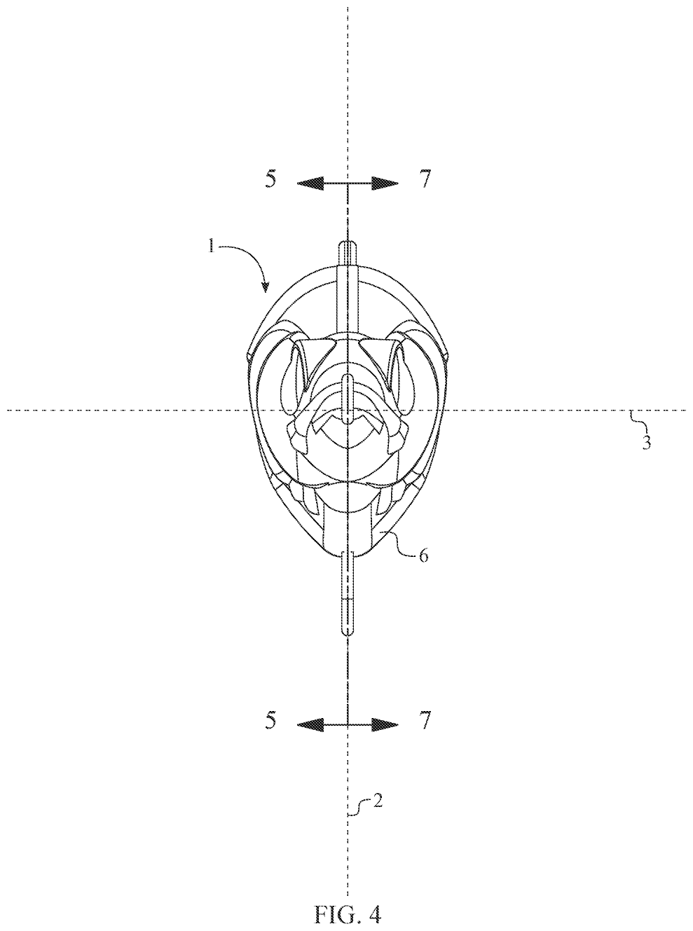

In reference to general configuration of the present invention, as shown in FIGS. 1-4, the lure body 1 is preferably formed into a fish-shaped and comprises a sagittal plane 2, a head section 4, a mid-section 5, a tail section 7, and a hook mount 8. The head section 4 and the tail section 7 are oppositely positioned of each other about the mid-section 5 thus delineating the general shape. The sagittal plane 2 is centrally positioned along the head section 4, the mid-section 5, and the tail section 7 so that the remaining components of the present invention can be oriented and explained in relative to the sagittal plane 2. The fishing hook 23 is configured similar to existing fishing hook 23s and comprises an eyelet 24 and a shank 25. The hook mount 8 is integrated into the mid-section 5 and provides a platform to mount the fishing hook 23. The hook-positioning compartment 14 is positioned in between the hook mount 8 and the tail section 7 and traverses into a belly portion 6 of the mid-section 5. The magnet 21 is hermetically mounted within the mid-section 5 and adjacently positioned atop the hook-positioning compartment 14. As a result, the hook-positioning compartment 14 and the magnet 21 are able to attach the fishing hook 23 magnetically and angularly to the fishing lure. More specifically, the eyelet 24 of the fishing hook 23 is slidably mounted to the hook mount 8 so that the eyelet 24 can be magnetically attached to the magnet 21 through the mid-section 5. When the fishing hook 23 is magnetically attached to the fishing lure, the eyelet 24 is partially positioned within the hook-positioning compartment 14 as the shank 25 of the fishing hook 23 is angularly positioned to the lure body 1. Even though present invention is explained in relation to a single configuration of the hook-positioning compartment 14, the magnet 21, and the fishing hook 23, it is understood that the present invention can comprise multiple configurations of the hook-positioning compartment 14, the magnet 21, and the fishing hook 23 without deviating from the scope of the functionality.

Even though the lure body 1 is formed into a fish-shape, the lure body 1 can also be of any other shape desired for attracting fish. In reference to FIGS. 1-4, the lure body 1 may further comprise a frontal plane 3. More specifically, the frontal plane 3 is positioned perpendicular to the sagittal plane 2 and along the head section 4, the mid-section 5, and the tail section 7. The lure body 1 may further comprise a line attachment mechanism, allowing the lure body 1 to be pulled by the fishing line. Preferably, the line attachment mechanism is attached to the head section 4 so that the most natural and hydrodynamic movement of the lure body 1 can be achieved through the water. The belly portion 6 is defined within the mid-section 5 so that the hook-positioning compartment 14 can be positioned in relation to the positioning of the fishing hook 23. It is understood that the lure body 1 may further comprise other existing features such as a diving lip, one or more stick attractors, fins, joints, or other related features that enhance the fishing experience.

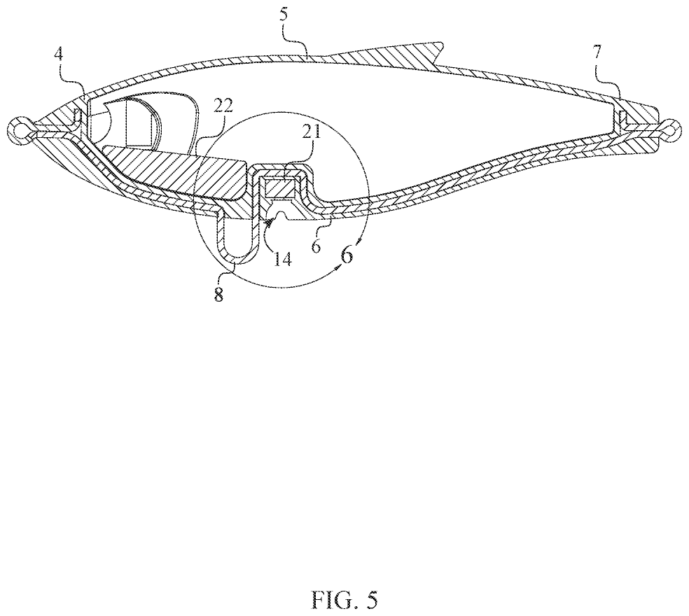

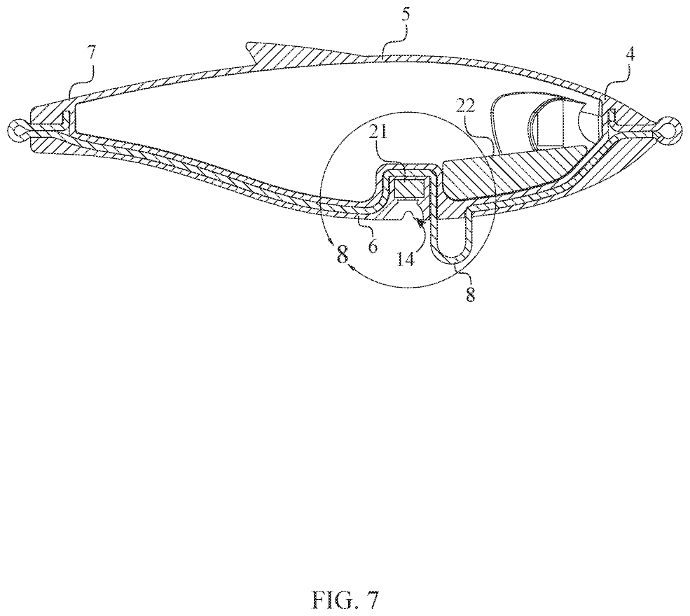

The hook mount 8 facilitates the attachment between the fishing lure and the fishing hook 23. In reference to FIGS. 5-8, the hook mount 8 may comprise a first shaft 9, a bend section 10, and a second shaft 13. The bend section 10 is positioned offset from the mid-section 5 and shaped into a U-shaped configuration. The first shaft 9 is terminally connected to a first end 11 of the bend section 10 and the mid-section 5. The second shaft 13 is terminally connected to a second end 12 of the bend section 10 and the mid-section 5. In other words, the first shaft 9 and the second shaft 13 terminally connect the bend section 10 onto the belly portion 6 of the mid-section 5. As a result, the fishing hook 23 can be slidably connected to the underside of the fishing lure via the hook mount 8. Even though the present invention utilize the preferred embodiment of the hook mount 8, it is understood that the present invention can utilize a channeled opening to the lure body 1, a triangular shaped mount, a curved shaped mount, or any other type of mounting mechanisms to slidably mount the fishing hook 23 to the lure body 1.

In reference to FIGS. 5-8, the present invention may further comprise a weight 22. The weight 22 is positioned within the lure body 1 and preferably positioned adjacent to the head section 4 to balance the lure body 1 with respect to the fishing hook 23. The exact positioning of the weight 22 is determined upon the number of fishing hooks 23 and the exact positioning of the fishing hooks 23 so that the lure body 1 can be pulled though the body of water similar to the swimming actions of the fish. It is understood that some embodiments of the present invention, the weight 22 can be positioned anywhere within the lure body 1 depending upon the desired swim action of the present invention. It is understood that some embodiments of the present invention can be configured without utilizing the weight 22.

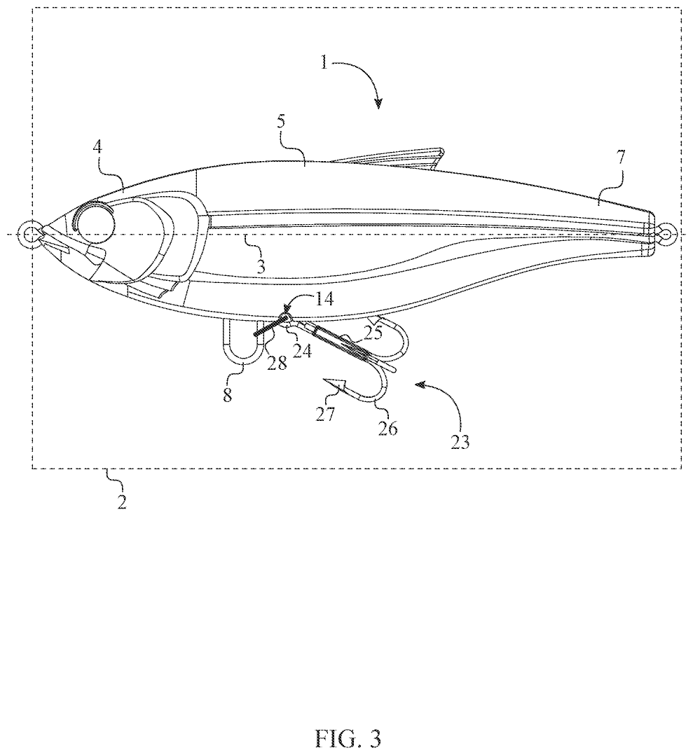

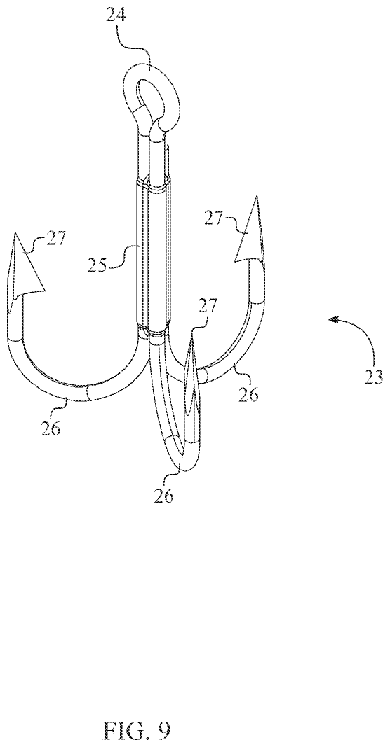

As shown in FIG. 3 and FIG. 9, the fishing hook 23 may further comprise at least one bend 26 and at least one barb 27. More specifically, the eyelet 24 is terminally connected to the shank 25. The bend 26 is terminally connected to the shank 25 as the bend 26 and the eyelet 24 are oppositely positioned of each other about the shank 25. The barb 27 is terminally connected to the bend 26 as the barb 27 and the shank 25 are oppositely positioned of each other about the bend 26. The bend 26 is oriented backward toward the eyelet 24 so that the fishing hook 23 can be configured similar to existing hooks. The fishing hook 23 is preferably a standard treble hook with a plurality of prongs (three prong hook) wherein the at least one bend 26 is three bends and the at least one barb 27 is three barbs. However, the fishing hook 23 may have any number of prongs arranged in any configuration. It is understood that some embodiments of the present invention, the fishing hook 23 can be configured without the barb 27 depending on user preference or industry regulations.

In reference to FIG. 3, the present invention may further comprise a ring connector 28 to facilitate the connection between the eyelet 24 of the fishing hook 23 and hook mount 8. Preferably, the ring connector 28 is a split ring or a double ring so that the fishing hook 23 can be easily removed when necessary. Furthermore, the ring connector 28 reduces the friction between the eyelet 24 of the fishing hook 23 and the hook mount 8 so that the fishing hook 23 can easily slide along the hook mount 8.

The hook-positioning compartment 14 is a cavity that traverses into the mid-section 5. The hook-positioning compartment 14 is preferably shaped into a ring portion and a slot portion. The ring portion is arranged closest to an outer surface of the lure body 1 and matches the shape of the ring connector 28 thus allowing the ring connector 28 to fit within. The slot portion intersects through the ring portion and is arranged deeper within the lure body 1 and further from the outer surface than the ring portion. The slot portion is preferably shaped to accept the eyelet 24 of the fishing hook 23.

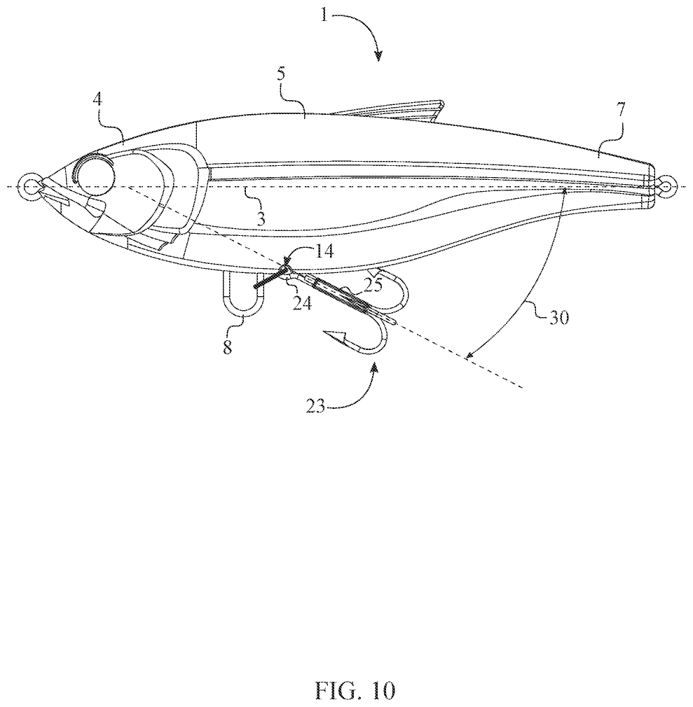

In reference to FIG. 3 and FIGS. 5-8, the hook-positioning compartment 14 may comprise a bottom wall 15, a front curved wall 16, a rear angled wall 17, a left lateral wall 18, and a right lateral wall 19 so that the slot portion can be defined. The bottom wall 15 is positioned parallel to the frontal plane 3 and defines the deepest portion of the hook-positioning compartment 14. The front curved wall 16 is positioned adjacent to the hook mount 8 and internally extended from the lure body 1 to the bottom wall 15. The rear angled wall 17 is positioned offset from the hook mount 8. The rear angled wall 17 is positioned in between the hook mount 8 and the tail section 7 in such a way that the rear angled wall 17 is internally extended from the lure body 1 to the bottom wall 15. The left lateral wall 18 is positioned parallel to the sagittal plane 2 and internally extended from the lure body 1 to the bottom wall 15, the front curved wall 16, and the rear angled wall 17. The right lateral wall 19 is positioned parallel to the sagittal plane 2 and internally extended from the lure body 1 to the bottom wall 15, the front curved wall 16, and the rear angled wall 17. In other words, the left lateral wall 18 and the right lateral wall 19 are positioned oppositely of each other about the sagittal plane 2 thus defining the width of the hook-positioning compartment 14. As a result, the bottom wall 15, the front curved wall 16, the rear angled wall 17, the left lateral wall 18, and the right lateral wall 19 are configured into the slot portion so that the eyelet 24 can be partially inserted into the slot portion and magnetically attached to the magnet 21. In reference to FIG. 10, the rear angled wall 17 and frontal plane 3 are angularly positioned about an acute angle 30 so the predetermined angle is able to dictate the angle that the fishing hook 23 sits relative to the lure body 1 and subsequently dictate the position of the at least one bend 26 as the present invention moves through the water. The acute angle 30 is approximately ranges from 30-60 degrees and preferably at 45 degrees as the exact degree of the acute angle 30 can change upon the shape of the lure body 1 and the shape of the hook mount 8.

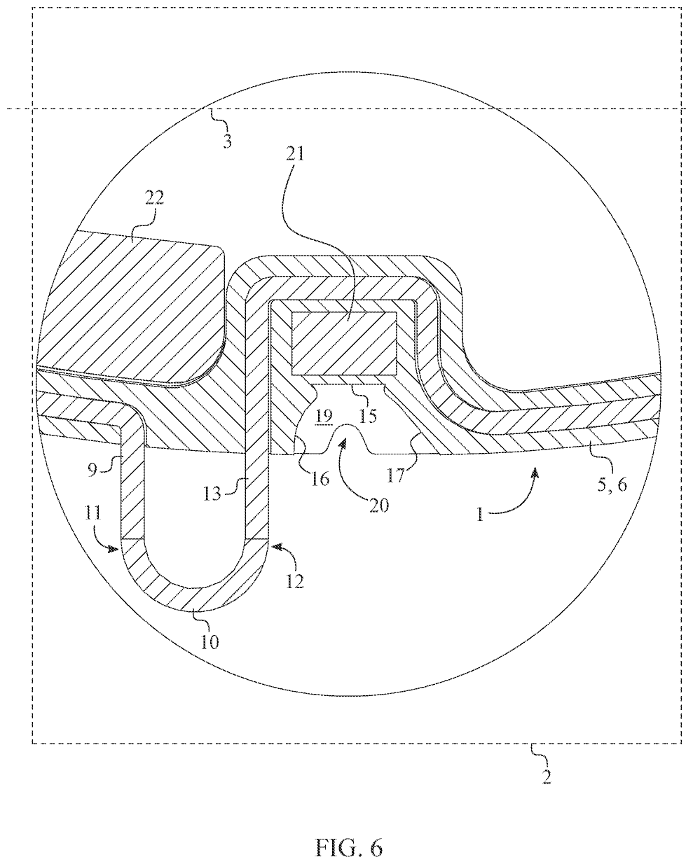

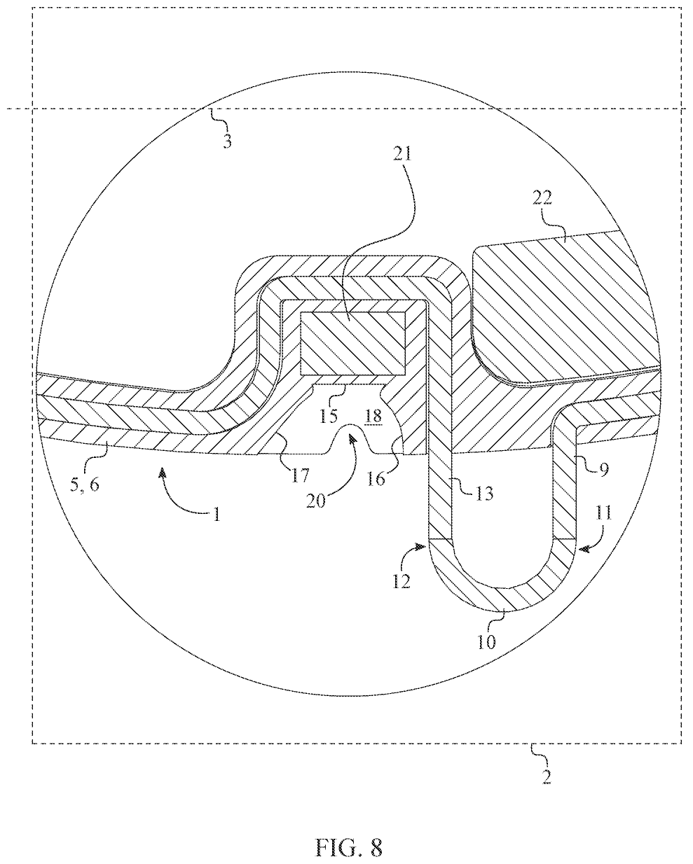

In reference to FIG. 6 and FIG. 8, the hook-positioning compartment 14 may further comprise a concave channel 20 so that the ring portion can be defined. More specifically, the concave channel 20 traverses through the lure body 1 and normal to the sagittal plane 2. The concave channel 20 is positioned perpendicular to the left lateral wall 18 and the right lateral wall 19 and positioned in between the front curved wall 16 and the rear angled wall 17. As a result, the concave channel 20 is configured into the ring portion so that the ring connector 28 can be positioned within to facilitate the magnetic attached the magnet 21 and the eyelet 24.

In reference to FIG. 6 and FIG. 8, the magnet 21 is positioned within the lure body 1, adjacent to the slot portion. Preferably, the magnet 21 is separated from the hook-positioning compartment 14 by a thin layer of material to prevent the magnet 21 from direct exposure to water during use. However, in some embodiments, the magnet 21 may be disposed directly within the hook-positioning compartment 14. The magnet 21 is configured to attract the eyelet 24 and hold the eyelet 24 and ring connector 28 within the hook-positioning compartment 14. The magnet 21 is preferably a single rectangular prism, but may be a sphere, disk, or any other shape and may also be a collection of multiple magnets.

Even though the present application depicts an embodiment having a single hook-positioning compartment 14, a single fishing hook 23, and a single magnet 21. However, the present invention can include multiple hook-positioning compartments 14, multiple fishing hooks 23, multiple magnets 21, and multiple hook mounts 8 with reference to the preferred orientation. Further, the multiple hook-positioning compartments 14, the multiple fishing hooks 23, the multiple magnets 21, and the multiple hook mounts 8 can be positioned on any surface of the lure body 1 and are not limited to the belly portion 6 of the midsection.

In use, as shown in FIG. 3, the ring connector 28 is attached to the hook mount 8 and the eyelet 24. The eyelet 24 and the ring connector 28 are then placed within the hook-positioning compartment 14 in such a way that the eyelet 24 rests in the slot portion and the ring connector 28 resting in the ring portion, held in place by the magnet 21. Part of the fishing hook 23 body, preferably the shank 25, may also rest against the hook-positioning compartment 14 thus positioning the fishing hook 23 at an angle based on the rear angled wall 17. A fishing line may be attached to the line attachment mechanism and the fishing lure may be cast into the water to be pulled along by the fishing line. When moving through the water, the magnet 21 holds the fishing hook 23 in the desired position with the eyelet 24 secured in the hook-positioning compartment 14. When force is applied to the fishing hook 23 by a fish or other object, the fishing hook 23 may be pulled out of the hook-positioning compartment 14. The magnet 21 and the hook-positioning compartment 14 not only hold the fishing hook 23 in a desired position for catching fish, but also hold the plurality of prongs of the fishing hook 23 in place during both use and storage, preventing the plurality of prongs from repeatedly brushing against the lure body 1, which can damage both the fishing hook 23 and the lure body 1.

Although the invention has been explained in relation to its preferred embodiment, it is to be understood that many other possible modifications and variations can be made without departing from the spirit and scope of the invention as hereinafter claimed.

What is claimed is:

1. A fishing lure with magnetic hook slot comprising:
a lure body;
a hook-positioning compartment;
a magnet;
a fishing hook;
the lure body comprising a sagittal plane, a head section, a mid-section, a tail section, and a hook mount;
the fishing hook comprising an eyelet and a shank;
the head section and the tail section being oppositely positioned of each other about the mid-section;
the sagittal plane being centrally positioned along the head section, the mid-section, and the tail section;
the hook mount being integrated into the mid-section;
the hook-positioning compartment being positioned in between the hook mount and the tail section;
the hook-positioning compartment traversing into a belly portion of the mid-section;
the magnet being hermetically mounted within the mid-section;
the magnet being adjacently positioned atop the hook-positioning compartment;
the eyelet being slidably mounted to the hook mount;
the eyelet being magnetically attached to the magnet through the mid-section;
the eyelet being partially positioned within the hook-positioning compartment; and
the shank being angularly positioned to the lure body.

2. The fishing lure with magnetic hook slot as claimed in claim 1 comprising:
the lure body further comprising a frontal plane;
the frontal plane being positioned perpendicular to the sagittal plane; and
the frontal plane positioned along the head section, the mid-section, and the tail section.

3. The fishing lure with magnetic hook slot as claimed in claim 1 comprising:
a weight;
the weight being mounted within the lure body; and
the weight being positioned adjacent to the head section.

4. The fishing lure with magnetic hook slot as claimed in claim 1 comprising:
a ring connector; and
the eyelet being slidably mounted to the hook mount through the ring connector.

5. The fishing lure with magnetic hook slot as claimed in claim 1 comprising:
the hook mount comprising a first shaft, a bend-section, and a second shaft;
the bend-section being positioned offset from the mid-section;
the first shaft being terminally connected to a first end of the bend-section and the mid-section; and
the second shaft being terminally connected to a second end of the bend-section and the mid-section.

6. The fishing lure with magnetic hook slot as claimed in claim 1 comprising:
the fishing hook further comprising at least one bend and at least one barb;
the eyelet being terminally connected to the shank;
the bend being terminally connected to the shank;
the bend and the eyelet being oppositely positioned of each other about the shank;
the barb being terminally connected to the bend; and
the barb and the shank being oppositely positioned of each other about the bend.

7. The fishing lure with magnetic hook slot as claimed in claim 1 comprising:
the hook-positioning compartment comprising a bottom wall, a front curved wall, a rear angled wall, a left lateral wall, and a right lateral wall;
the bottom wall being positioned parallel to a frontal plane of the lure body;
the front curved wall being positioned adjacent to the hook mount;
the rear angled wall being positioned offset from the hook mount;
the rear angled wall being positioned in between the hook mount and the tail section;
the left lateral wall being positioned parallel to the sagittal plane;
the right lateral wall being positioned parallel to the sagittal plane; and
the left lateral wall and the right lateral wall being oppositely positioned of each other about the sagittal plane.

8. The fishing lure with magnetic hook slot as claimed in claim 7 comprising:
the front curved wall being internally extended from the lure body to the bottom wall;
the rear angled wall being internally extended from the lure body to the bottom wall;
the left lateral wall being internally extended from the lure body to the bottom wall, the front curved wall, and the rear angled wall; and
the right lateral wall being internally extended from the lure body to the bottom wall, the front curved wall, and the rear angled wall.

9. The fishing lure with magnetic hook slot as claimed in claim 7 comprising:
the hook-positioning compartment further comprises a concave channel;
the concave channel traversing through the lure body;
the concave channel being positioned perpendicular to the left lateral wall and the right lateral wall; and
the concave channel being positioned in between the front curved wall and the rear angled wall.

10. The fishing lure with magnetic hook slot as claimed in claim 7, wherein the rear angled wall and the frontal plane are angularly positioned at about an acute angle.

11. A fishing lure with magnetic hook slot comprising:
a lure body;
a hook-positioning compartment;
a magnet;
a fishing hook;
the lure body comprising a sagittal plane, a head section, a mid-section, a tail section, and a hook mount;
the hook-positioning compartment comprising a bottom wall, a front curved wall, a rear angled wall, a left lateral wall, and a right lateral wall;
the fishing hook comprising an eyelet and a shank;
the head section and the tail section being oppositely positioned of each other about the mid-section;
the sagittal plane being centrally positioned along the head section, the mid-section, and the tail section;
the hook mount being integrated into the mid-section;
the hook-positioning compartment being positioned in between the hook mount and the tail section;
the hook-positioning compartment traversing into a belly portion of the mid-section;
the bottom wall being positioned parallel to a frontal plane of the lure body;
the front curved wall being positioned adjacent to the hook mount;
the rear angled wall being positioned offset from the hook mount;
the rear angled wall being positioned in between the hook mount and the tail section;
the left lateral wall being positioned parallel to the sagittal plane;
the right lateral wall being positioned parallel to the sagittal plane;
the left lateral wall and the right lateral wall being oppositely positioned of each other about the sagittal plane;
the magnet being hermetically mounted within the mid-section;
the magnet being adjacently positioned atop the hook-positioning compartment;
the eyelet being slidably mounted to the hook mount;
the eyelet being magnetically attached to the magnet through the mid-section;
the eyelet being partially positioned within the hook-positioning compartment; and
the shank being angularly positioned to the lure body.

12. The fishing lure with magnetic hook slot as claimed in claim 11 comprising:
the lure body further comprising a frontal plane;
the frontal plane being positioned perpendicular to the sagittal plane; and
the frontal plane positioned along the head section, the mid-section, and the tail section.

13. The fishing lure with magnetic hook slot as claimed in claim 11 comprising:
a weight;
the weight being mounted within the lure body; and
the weight being positioned adjacent to the head section.

14. The fishing lure with magnetic hook slot as claimed in claim 11 comprising:
a ring connector; and
the eyelet being slidably mounted to the hook mount through the ring connector.

15. The fishing lure with magnetic hook slot as claimed in claim 11 comprising:
the hook mount comprising a first shaft, a bend-section, and a second shaft;
the bend-section being positioned offset from the mid-section;
the first shaft being terminally connected to a first end of the bend-section and the mid-section; and
the second shaft being terminally connected to a second end of the bend-section and the mid-section.

16. The fishing lure with magnetic hook slot as claimed in claim 11 comprising:
a fishing hook further comprising at least one bend and at least one barb;
the eyelet being terminally connected to the shank;
the bend being terminally connected to the shank;
the bend and the eyelet being oppositely positioned of each other about the shank;
the barb being terminally connected to the bend; and
the barb and the shank being oppositely positioned of each other about the bend.

17. The fishing lure with magnetic hook slot as claimed in claim 11 comprising:
the front curved wall being internally extended from the lure body to the bottom wall;
the rear angled wall being internally extended from the lure body to the bottom wall;
the left lateral wall being internally extended from the lure body to the bottom wall, the front curved wall, and the rear angled wall; and
the right lateral wall being internally extended from the lure body to the bottom wall, the front curved wall, and the rear angled wall.

18. The fishing lure with magnetic hook slot as claimed in claim 11 comprising:
the hook-positioning compartment further comprises a concave channel;
the concave channel traversing through the lure body;
the concave channel being positioned perpendicular to the left lateral wall and the right lateral wall; and
the concave channel being positioned in between the front curved wall and the rear angled wall.

19. The fishing lure with magnetic hook slot as claimed in claim 11, wherein the rear angled wall and the frontal plane are angularly positioned at about an acute angle.
